(19) United States
(12) Patent Application Publication
(10) Pub. No.: US 2017/0275025 A1
(43) Pub. Date: Sep. 28, 2017

(54) LUMINAIRE-MOUNTED LANDING PLATFORM FOR A DRONE

(71) Applicant: GE Lighting Solutions, LLC, East Cleveland, OH (US)

(72) Inventors: David Mark JOHNSON, East Flat Rock, NC (US); Kenneth A. LANE, East Flat Rock, NC (US)

(21) Appl. No.: 15/159,554

(22) Filed: May 19, 2016

Related U.S. Application Data
(60) Provisional application No. 62/312,960, filed on Mar. 24, 2016.

(51) Int. Cl. B64F 1/36; B64F 1/00; F21V 33/00; G05D 1/10; F21S 8/08; B64F 1/12; B64C 39/02

(52) U.S. Cl. CPC B64F 1/362; B64F 1/12; B64F 1/005; B64C 39/024; G05D 1/101; F21S 8/08; F21V 33/008; B64C 2201/066; B64C 2201/146

(57) ABSTRACT

There is provided a landing platform for mounting on a luminaire, where the landing platform provides an interface to a drone. For example, there is provided a landing platform for a drone, the landing platform being adaptable to mount on a luminaire. The landing platform includes two electrically active portions and an elevated portion. The elevated portion is configured to secure the drone on the landing platform and provide electrical contact between the two electrically active portions and electrical connectors of the drone.

### RELATED APPLICATIONS

The instant application is a nonprovisional of, and claims benefit under 35 USC 119(e) of, prior-filed commonly owned copending U.S. provisional application 62/312,960, filed 24 Mar. 2016, which is hereby incorporated by reference in its entirety.

### TECHNICAL FIELD

The present disclosure generally relates to luminaires. More particularly, the present disclosure relates to luminaires equipped with drone landing platforms.

### BACKGROUND

The use of drones or micro-air vehicles is now widespread in recreational activities, military and police applications, and industrial applications. There is a trend to miniaturize drones in order to deploy fleets of drones that can cover a wide area. For example, for drones that are equipped with cameras and/or sensors, a fleet of drones may provide data, images or video covering a large area all at once. Unfortunately, this miniaturization trend comes at the expense of battery life because smaller batteries must be used, which therefore reduces the travel range of the drones.

### SUMMARY

Given the aforementioned deficiencies, a need exists to provide charging infrastructure for miniature drones in order to extend their travel ranges. The embodiments featured herein help mitigate the above-noted deficiencies as well as other issues known in the art. For example, in the embodiments the range of drones can easily be extended by providing charging infrastructure along a route, where the drone can periodically land to recharge its batteries. Moreover, in security applications, the embodiments allow a much wider and customizable camera coverage areas than what is currently possible with fixed camera systems.

One embodiment includes a landing platform for a drone adaptable to mount on a luminaire. The landing platform includes two electrically active portions and an elevated portion. The elevated portion is configured to secure the drone on the landing platform and provide electrical contact between the two electrically active portions and electrical connectors of the drone.

Another embodiment includes a method for charging a drone. The method includes guiding the drone onto a body of the luminaire, where the body of the luminaire is fitted with a landing platform. The method further includes securing the drone onto the landing platform and providing electrical contact between connectors of the drone and at least two electrically active portions of the landing platform.

Another embodiment includes a drone undercarriage configured to interface with a landing platform mounted on a luminaire. The undercarriage includes at least two brushes configured to provide electrical contact between the drone's batteries and two downwardly sloping electrically active portions of the landing platform.

Another embodiment includes a controller programmable to create an interface between a drone and a power charging circuit included in a luminaire. The controller includes a processor and a memory including instructions that, when executed by the processor, cause the processor to perform certain operations. The operations can include detecting the presence of the drone within a predefined radius of the luminaire. The operations can further include instructing the drone to enter a landing sequence when the drone is found to be present within the predefined radius. Furthermore, the operations can include detecting a polarity associated with a connector of the drone, upon the drone having landed on a landing platform of the luminaire. Moreover, the operations can include energizing at least one electrically active portion of the landing platform according to the detected polarity in order to charge batteries of the drone with the power charging circuit.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an illustration of one exemplary embodiment of the present invention.

FIG. 2 is an illustration of another exemplary embodiment.

FIG. 3 is an illustration of an exemplary platform, according to an embodiment.

FIG. 4 is an illustration of an exemplary drone according to another embodiment.

FIG. 5 is an illustration of a drone, according to yet another embodiment.

FIG. 6 is an illustration of an exemplary platform, according to an embodiment.

FIG. 7 is an illustration of an exemplary canopy being half-deployed over a luminaire, according to an embodiment.

FIG. 8 is a side view of an exemplary luminaire, according to an embodiment.

FIG. 9 is a top view of the exemplary luminaire of FIG. 8.

FIG. 10 depicts a flow chart of a method according to an embodiment.

FIG. 11 is a block diagram of a device, according to an embodiment.

FIG. 12 is an illustration of another exemplary platform, according an embodiment.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

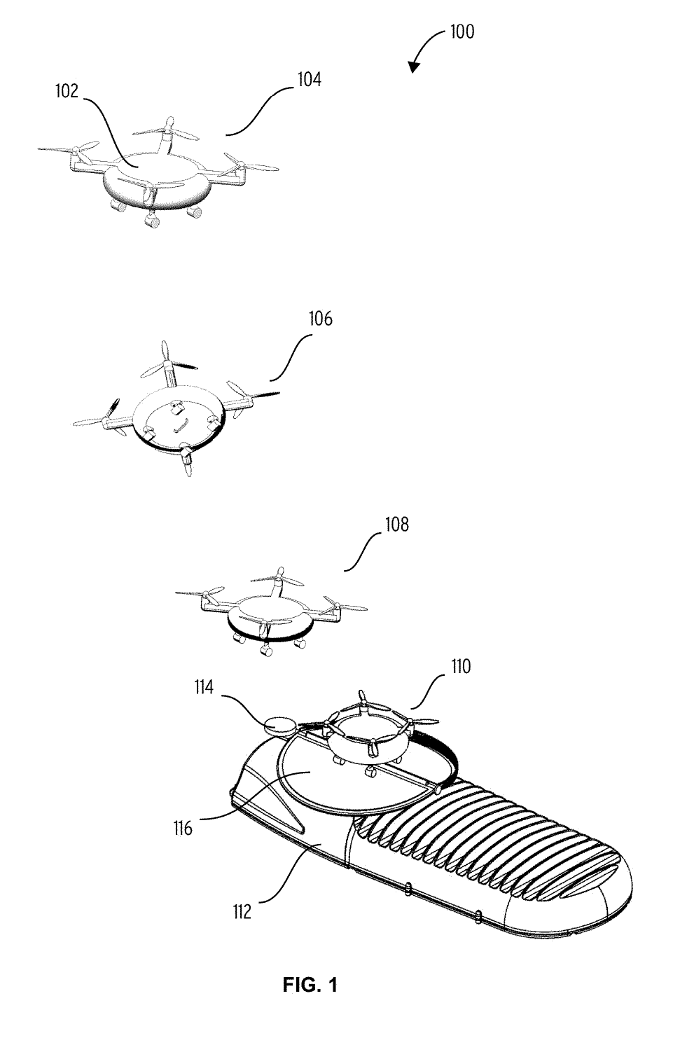

FIG. 1 is an illustration of a scenario 100 according to an embodiment. A drone 102 can enter a landing pattern to land on a platform 116 located on a portion of a pole-mounted luminaire 112. The landing pattern is illustrated as drone 102 being successively located at positions 104, 106, 108, and at a landing position 110. In some embodiments, drone 102 can be controlled by a user as it approaches luminaire 112. Once within a predetermined distance of luminaire 112, drone 102 can switch to an automatic control mode (i.e. a landing sequence) designed to guide it on platform 116. The user may override the control mode to abort the landing pattern and cause drone 102 to fly away from luminaire 112.

In other embodiments, drone 102 may be an autonomous micro-air vehicle (MAV) or any other autonomous aerial vehicle. For example, drone 102 can be pre-programmed to fly a certain route, and upon one or more events occurring, drone 102 can be pre-programmed to land at a waypoint along the route. The waypoint can be luminaire 112. One event that can cause drone 102 to land on luminaire 112 can be when the charge on one or more batteries falls below a threshold. At that point, drone 102 can land on platform 116 to recharge its batteries.

Luminaire 112 can be equipped with circuitry within its body where the circuitry is configured to recharge drone 102 via an electrical interface provided by platform 116. The interface can be through direct contact between portions of platform 116 and at least two pins, or brushes, or legs located on an undercarriage of drone 102.

In other embodiments, the undercarriage of drone 102 may have no electrical contacts. Rather, drone 102 and luminaire 112 can both include circuitry, which when in close proximity, allow energy transfer by induction. In other words, luminaire 112 can be configured to charge drone 102 wirelessly.

In some embodiments, when drone 102 is secured on platform 116, the power consumption of drone 102 resulting from it being charged by luminaire 112 can be monitored so that a user can be can billed for service. The drone 102 can have information stored in its internal memory and accessible to one or more circuits included in luminaire 112. For example, drone 102 can include video data downloadable by one or more circuits within luminaire 112 and subsequently transmitted to a control station coupled to a wireless node (not shown) coupled to connector 114.

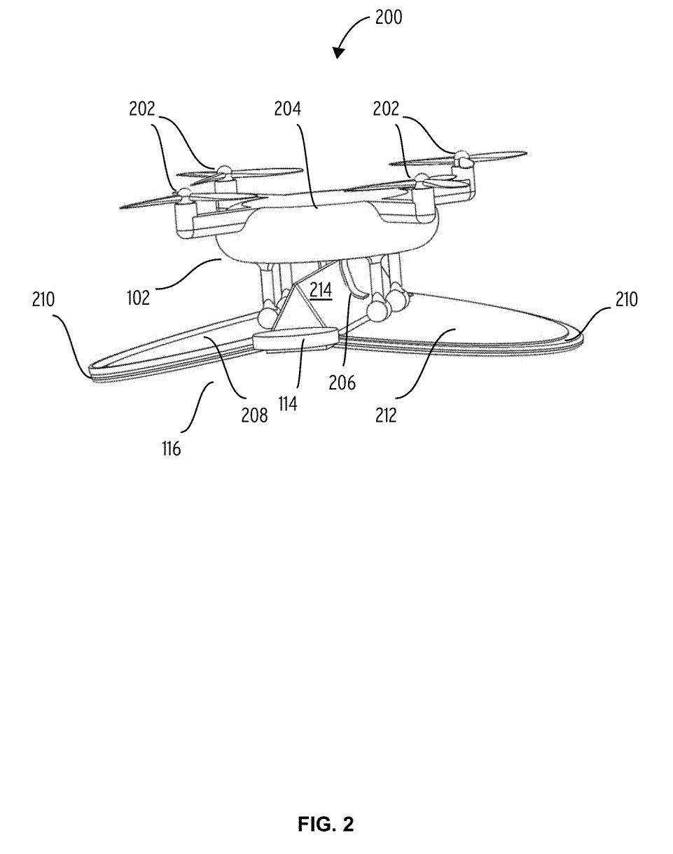

FIG. 2 is an illustration of a scenario 200, according to an embodiment. Scenario 200 shows drone 102 having landed on platform 116, which includes a first charging pad 208 and a second charging pad 212. Once landed, drone 102 may receive a command to stop propellers 202. Platform 116 includes two portions (charging pads 208 and 212) that are sloped downward about a centerline (elevated portion 214). The two portions are so configured to passively provide stability to drone 102 once it has landed.

In some embodiments, elevated portion 214 can be an insulator, in other embodiments it can be metallized on both sides to provide connectivity to charging pads 208 and 212. As a result of the downward sloping configuration of the electrically active portions on each side of platform 116, debris, water, salt, and weather are less likely to create short circuits between charging pads 208 and 212.

Charging pad 208 and charging pad 212 can each have a predetermined polarity. The charging pads make contact with drone 102 at elevated portion 214, which can provide electrical connectivity to each one of the charging pad, in one embodiment. For example, charging pad 212 is electrically coupled to brush 206 of the drone 102 by the side of elevated portion 214.

Charging pad 208 can be of positive polarity and charging pad 212 can be of negative polarity or vice versa. In such embodiments, the landing sequence of drone 102 includes checking the orientation of drone 102 with respect to the orientation of the charging pads, in order to ensure that the positive port of the drone's batteries are connected to the positive charging pad and that the negative port of the drone's batteries are connected to the negative charging pad.

In some embodiments, the charging pads can be color-coded, and the landing sequence of drone 102 can include positioning drone 102 by visual feedback. The visual feedback can be performed by detecting the colors of the pads using a camera disposed within body 204 of drone 102. One of skill in the art will appreciate that color is one of many ways to identify the charging pads. In general, any distinguishable marker can be used to guide drone 102 onto platform 116 by visual feedback.

In other embodiments, drone 102 can land in an arbitrary position onto elevated portion 214. Electric circuitry within luminaire 112 can sense the orientation of drone 102 and provide the appropriate polarity to charge the batteries of drone 102. This may be achieved by sensing residual charge on the brushes of drone 102 or other polarity sensing methods known in the art. In other embodiments, brush 206 may have no electrical connectivity to either pads of platform 116. As mentioned above, in these embodiments, drone 102 may be charged wirelessly.

Generally speaking, as shown in FIG. 2, elevated portion 214 provides a mechanical support for securing drone 102. It may or may not provide electrical connectivity to drone 102, depending on the embodiment. Furthermore, platform 118 includes a retractable canopy 210 that can cover drone 102 to protect it from the elements. In a particular scenario, canopy 210 can be deployed before being retracted as drone 102 enters its landing sequence. Canopy 210 can be a protective fabric, like a cloth or a polymeric material, for example, and its purpose is to provide an environmental cover to isolate drone 102 from the elements, once it has landed.

Once drone 102 has landed, canopy 210 can be deployed to protect drone 102. In other cases, canopy 210 can be deployed only when drone 102 is present. Deployment and/or retraction of canopy 210 can be achieved either automatically or upon receiving a command at a controller circuit located within luminaire 112.

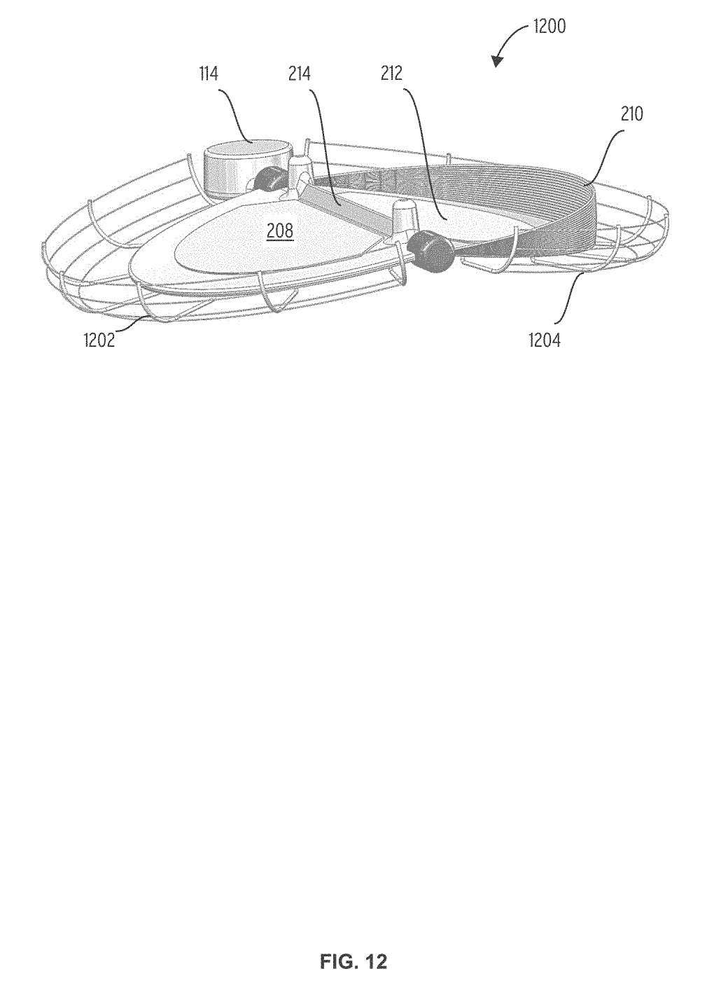

In yet other embodiments, platform 116 can be equipped with ‘safety net’ feature to prevent drone 102 from falling on the ground in case of an improper landing. Such an embodiment 1200 is shown in FIG. 12. Safety features 1202 and 1204 can be added on the sides of charging pad 208 and charging pad 212. Safety features 1202 and 1204 can be made of metal, plastic, or any other suitable material. Therefore, in a case where drone 102 fails to secure itself at elevated portion 214, drone 102 will simply slide off either side charging pads 208 or 212, and it will be caught by one of safety features 1202 and 1204.

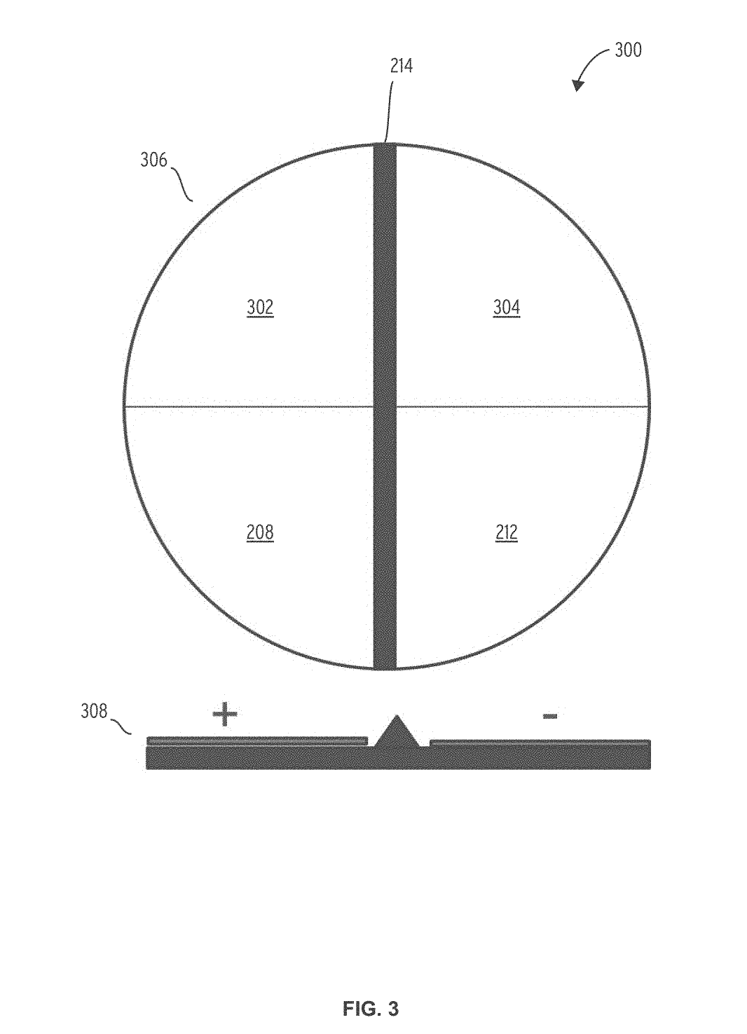

FIG. 3 is an illustration of a platform 300 similar to platform 116, according to an embodiment. Unlike platform 116, platform 300 can accommodate more than one drone. For example, charging pad 208 and charging pad 212 can be reserved for one drone while charging pad 302 and charging pad 304 can be reserved for another drone. Side view 308 shows the polarities corresponding to pads on each side of elevated portion 214.

In other embodiments, polarities can be different on one side of elevated portion 214. Furthermore, elevated portion 214 can have electrical discontinuities between adjacent pads to ensure independent control. For example, a drone charging on pads 302 and 304 is not electrically coupled to a drone charging on pads 208 and 212.

While only two pairs of pads are shown, a plurality of pad pairs can be added on platform 300 to support a plurality of drones. In other embodiments, a drone secured onto one side of platform 300 can transfer data or charge to another drone secured onto another side of platform 300 by using circuitry in the underlying luminaire as an intermediary.

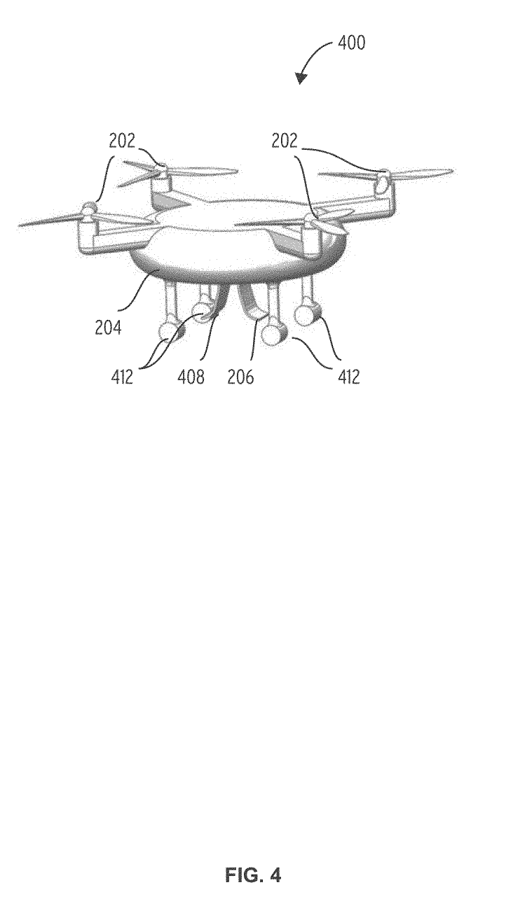

FIG. 4 is an illustration of a drone 400, according to an embodiment. Drone 400 includes a pair of brushes (brush 408 and brush 206) that can serve to charge drone 400 once it has landed, as described with respect to the previous figures. In other embodiments, brush 408 and brush 206 can be used to only secure drone 400 to elevated portion 214 of platform 116. In such embodiments, electrical is not needed to charge drone 400. Rather induction is used to wirelessly charge drone 400 and/or to transmit to or receive information from drone 400.

In some embodiments, brushes 206 and 408 can be retractable from within body 204 of drone 400, much like an airplane retracting its landing gear after takeoff. In these embodiments, drone 400 can deploy brushes 206 and 408 once it has entered its landing sequence. Furthermore, when secured to a platform, drone 102 can retract brushes 408 and 206 when its batteries reach or exceed a predetermined charge or time threshold, and/or upon receiving an instruction to do so. In these situations, propellers 202 are engaged and drone 400 is ready to take flight off the platform.

Furthermore, in some embodiments, any drone can be retrofitted with a kit to provide compatibility with platform 116. For example, the kit can include brushes with adhesive back that can be applied to existing drone legs having lead wires to connect to battery-charging input terminals of the drone. The brushes can be configured in ‘a snap on’ arrangement to connect to the battery-charging input terminals or they may be zip-tied thereto.

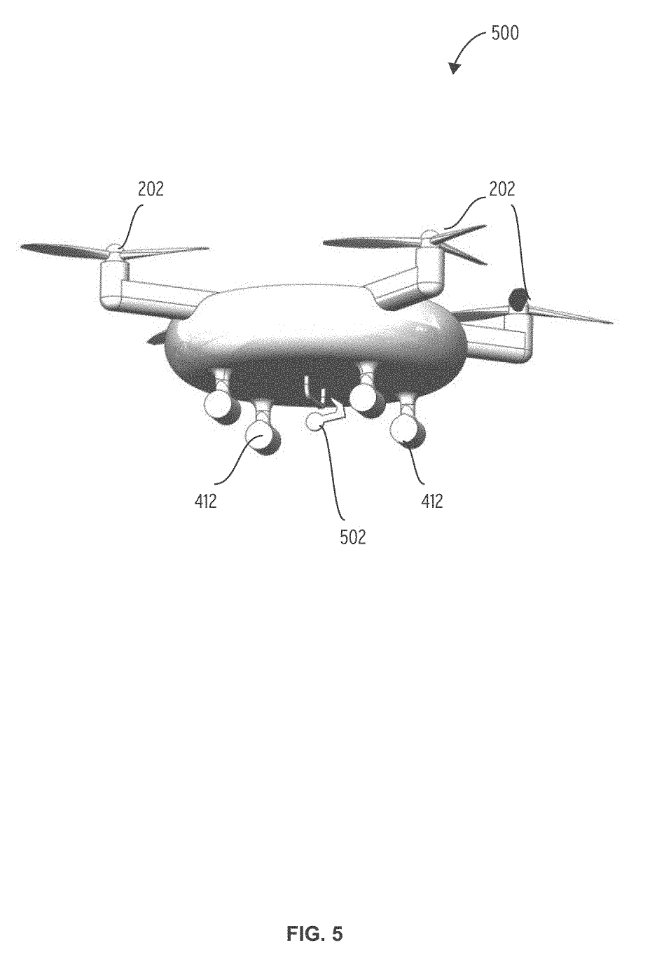

Furthermore, existing drones can be fitted with a hook, as shown in FIG. 5 to provide the undercarriage height necessary for interfacing with platform 116. Moreover, insulators can be applied to any conductive feet on a drone that would interfere with the previously mentioned embodiments. Yet in other embodiments, “boots” can be applied to drone legs to provide lead wires that connect to battery charging input terminals. As such, any drone can be retrofitted to function with platform 116.

In other embodiments, brushes 408 and 206 can be used for mechanical support, as explained above. However, charging can be provided via legs 412, which can provide electrical connection between circuits/batteries included in body 104 and the platform onto which drone 400 is secured. For example, a first pair of legs 412 (or one leg) on one side of drone 400 can be a positive charging terminal, and a second pair of legs 412 (or another leg) on the other side of drone 400 can be a negative charging terminal. In some embodiments, a pair of diagonally opposed legs may have opposite polarities so that when drone 102 lands, the pair of legs straddles elevated portion 214.

FIG. 5 is an illustration of a drone 500 according to yet another embodiment. Drone 500 can include a hook 502 configured to latch onto a feature of a platform disposed on a portion of a luminaire. Hook 502 can be retractable, or it can be magnetically or electromechanically actuated to secure drone 500 in place. Once drone 500 receives a command to take flight, hook 502 can be retracted and drone 500 can take flight.

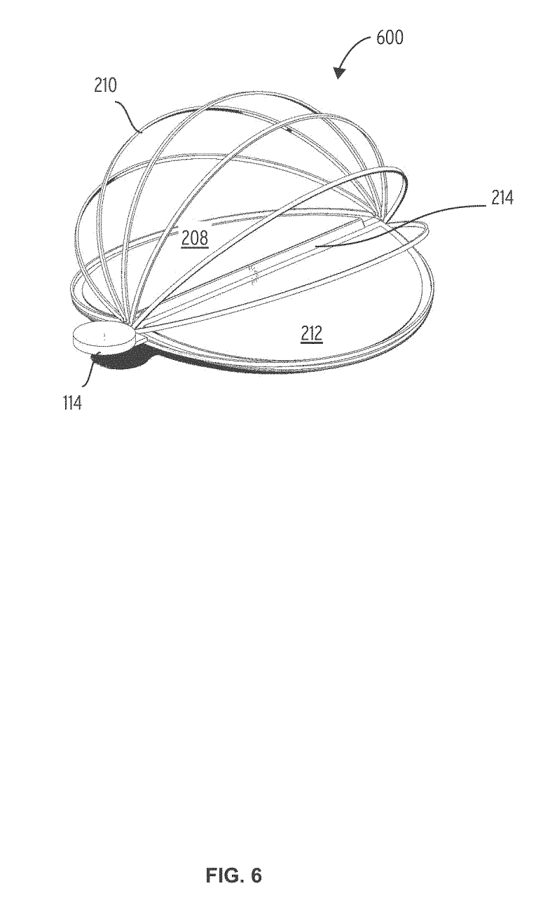

FIG. 6 is an illustration of a platform 600 according to an embodiment. Canopy 210 can be deployed over the region spanned by charging pad 208 and charging pad 212. Canopy 210 can be deployed or retracted by receiving a command from circuitry located in the underlying luminaire. Canopy 210 is made of a fabric (not shown) that is supported by hemispheric metal or plastic rings that can be actuated to form a dome-like structure over the charging pads.

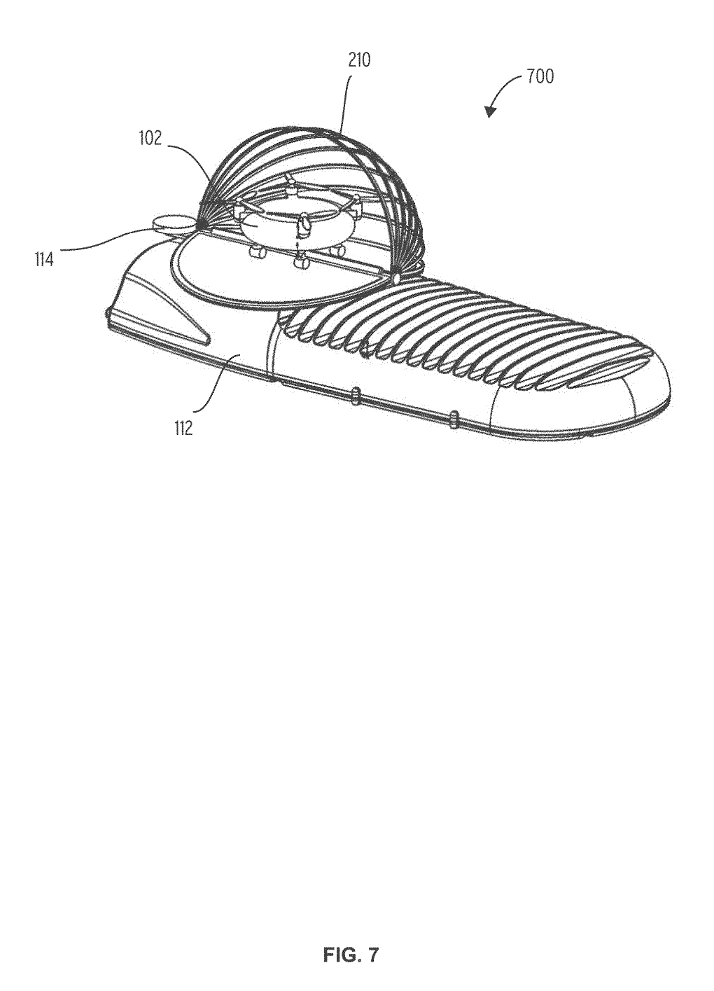

FIG. 7 is an exemplary scenario 700 where canopy 210 is deployed over luminaire 112 while drone 102 is secured on platform 116. The fabric covering canopy 210 can be a plastic tarp, which can be transparent or opaque. Canopy 210 can be actuated by stepper motors located within luminaire 112.

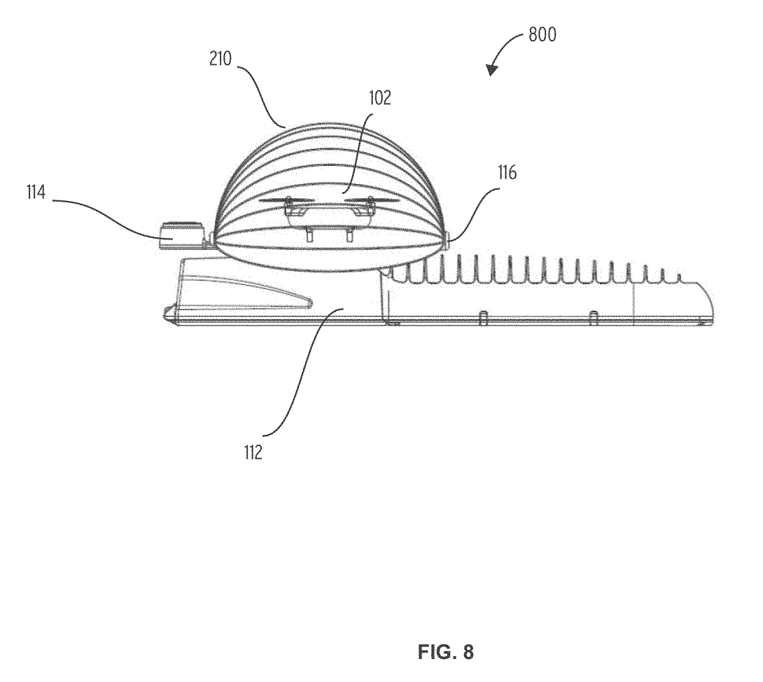

FIG. 8 is a side view 800 of luminaire 112, with canopy 210 completely closed and drone 102 being located therein and onto platform 116. In some embodiments, platform 116 may be part of a retrofit kit that can readily be attached to the default connector (not shown) of luminaire 112. The default connector is a connector that is typically found on luminaire portion, and its purpose is to provide an interface to circuitry located inside luminaire 112. It can also be used to mount a wireless node and/or a photoelectric element that is configured to instruct the luminaire to turn on or off based on a comparison between a predetermined threshold and measured ambient light intensity.

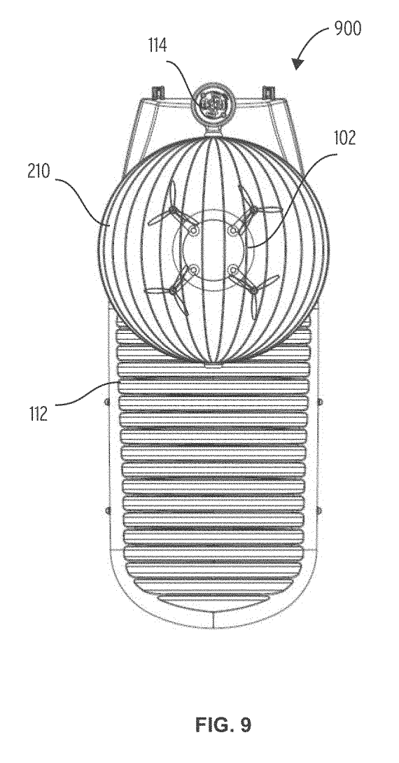

By plugging in platform 116 onto the default connector of luminaire 112, the default connector is thus obstructed. However, platform 116 has an extension (connector 114) at one extremity that replicates and connects to the default connector. Therefore, luminaire 112 loses none of its original functionality with the addition of platform 116. In some embodiments, platform 116 can be integrated in the body of luminaire 112 during manufacture. In other embodiments, platform 116 and connector 114 can be part of a kit connectable to existing luminaires to retrofit them with drone landing pad capability. FIG. 9 is a top view 900 of luminaire 112 with canopy 210 being closed. Specifically, platform 116 can have a plug underneath that connects to a luminaire's traditional photo-electric (PE) receptacle. Connector 114 can then be connected to the PE receptacle via wires or paths disposed under platform 116. As such, connector 114 allows the luminaire to still have its original functionality by functioning as a PE receptacle, and pads 208 and 212 can be energized by tapping power from the wires or paths disposed underneath platform 116.

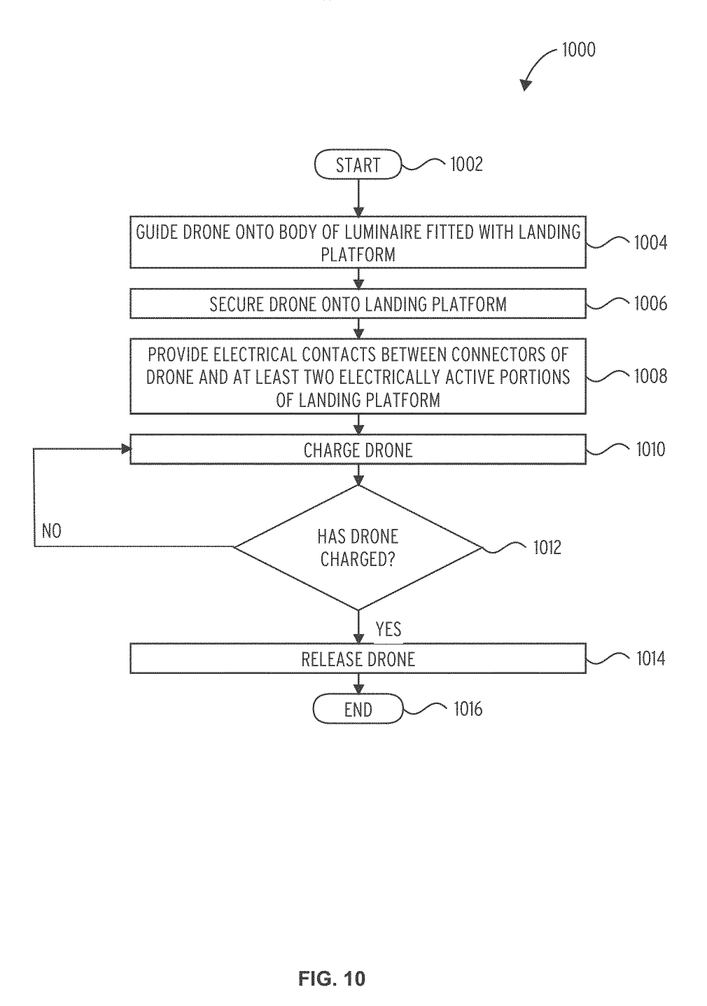

Having set forth various embodiments of the invention, a method consistent with their operation is described with respect to FIG. 10. Method 1000 begins at block 1002 and includes guiding a drone onto the body of a luminaire (block 1004), wherein the body of the luminaire is fitted with a platform like the ones previously described. Method 1000 further includes securing the drone onto the platform (block 1006). This can be achieved by deploying mechanical components included in the drone's undercarriage. Furthermore, securing the drone can include deploying a canopy over the platform to protect the drone.

Method 1000 further includes providing electrical contacts between connectors of the drone and at least two electrically active portions of the landing platform (block 1008). Once completed, charging or transfer information between the drone and the luminaire can begin (block 1010). In the former case, a controller within the luminaire can be used to check whether charging is completed (block 1012), i.e. whether batteries of the drone have exceed a predetermined charge level.

Once charging is completed, the controller can issue a command to the drone to retract its securing elements, and to retract the canopy (block 1014). Method 1000 ends at block 1016.

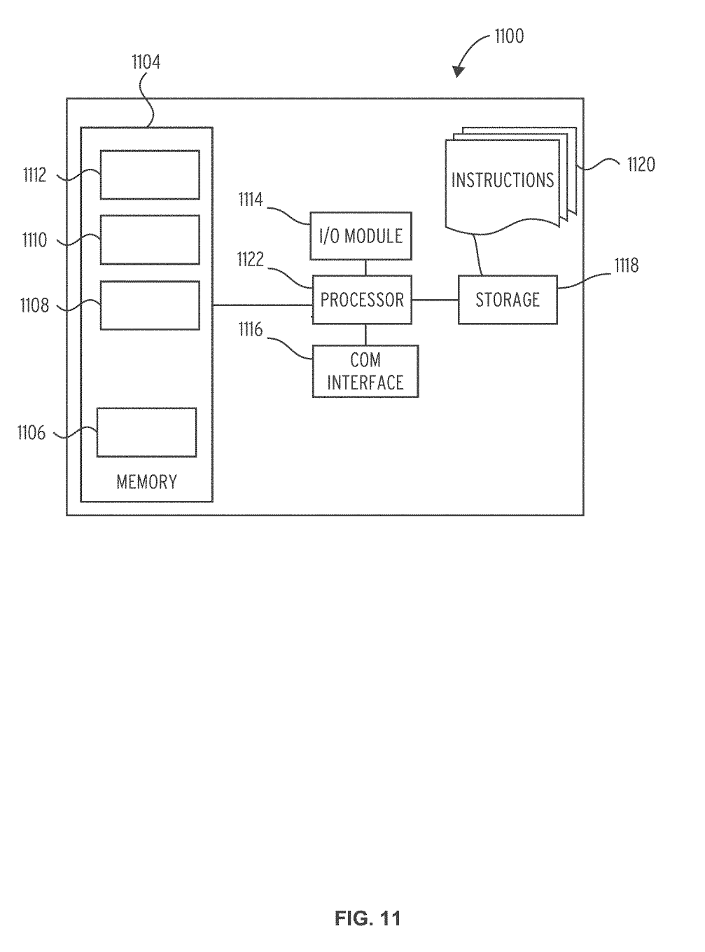

FIG. 11 is block diagram illustration of system controller 1100, which can include a processor 1122 that has a specific structure. The specific structure is imparted to processor 1122 by instructions stored in a memory 1104 included therein and/or by instructions 1120 that can be fetched from a storage medium 1118. The storage medium 1118 may be co-located with controller 1100 as shown, or can be located elsewhere, communicatively coupled to controller 1100.

The controller 1100 can be a stand-alone programmable system, or a programmable module located inside a luminaire. In other embodiments, controller 1100 can be a module located in a control node attached to the luminaire via a connector, such as connector 114 in the previously described figures.

The controller 1100 can include one or more hardware and/or software components configured to fetch, decode, execute, store, analyze, distribute, evaluate, and/or categorize information. One such component can be and input/output hardware (I/O module 1114) configured to interface with sensors, power charging circuits, and other electrical circuitry located in the luminaire.

Processor 1122 may include one or more processing devices or cores (not shown). In some embodiments, processor 1122 may be a plurality of processors, each having either one or more cores. Processor 1122 can be configured to execute instructions fetched from memory 1104, i.e. from one of memory block 1122, memory block 1110, memory block 1108, or memory block 1106, or the instructions may be fetched from storage medium 1118, or from a remote device connected to device 1100 via communication interface 1116.

Furthermore, without loss of generality, storage medium 1118 and/or memory 1104 may include a volatile or non-volatile, magnetic, semiconductor, tape, optical, removable, non-removable, read-only, random-access, or any type of non-transitory computer-readable medium.

Storage medium 1118 and/or memory 1104 can include programs and/or other information that may be used by processor 1122. Storage medium 1118 can be configured to log data processed, recorded, or collected during the operation of controller 1100. The data may be time-stamped, location-stamped, cataloged, indexed, or organized in a variety of ways consistent with data storage practice. Storage medium 1118 can include databases that store information relating to drone power consumption, and landing and departure times, for example.

In some embodiments, for example, memory block 1108 can include instructions that, when executed by processor 1122, cause processor 1122 to perform certain operations. The operations can include detecting, via proximity sensors (such as photodiodes), whether a drone is near the landing platform of the luminaire. In the case that the drone is near, processor 1122 can instruct stepper motors included in the luminaire to deploy the canopy.

Once the drone has landed, processor 1122 can cause the canopy to be closed and initiate charging of the drone. In some embodiments, processor 1122 can include sensing an orientation of the drone and subsequently assign a polarity to charging pads of the platform, as a result of the sensed orientation. This can be achieved via polarity sensing circuity within the luminaire or at a control node attached thereto.

Processor 1122 can further execute instructions from memory block 1108 to determine whether a drone's batteries have exceeded a desired threshold. When the batteries have exceed the threshold, the canopy can be retracted and the drone released, upon receiving an instruction from the processor to take flight.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A landing platform for landing a drone on a luminaire, the landing platform being adaptable to mount on the luminaire, the landing platform comprising:
two electrically active portions sloping downwardly about a centerline; and
an elevated portion disposed at the centerline, the elevated portion being configured to secure the drone on the landing platform to provide electrical contact between the two electrically active portions and electrical connectors of the drone.

2. The landing platform of claim 1, further comprising a moveable canopy.

3. The landing platform of claim 2, wherein the canopy is supported by a plurality of hemispheric rings.

4. The landing platform of claim 2, wherein the canopy is made of a protective fabric.

5. The landing platform of claim 1, further comprising an extended connector at one extremity, the extended connector being electrically coupled to a photo-electric element (PE) receptacle of the luminaire and to the landing platform.

6. The landing platform of claim 5, wherein the extended connector is electrically coupled to a connector disposed on a portion of the luminaire.

7. The landing platform of claim 1, wherein each of the two electrically active portions is associated with a respective polarity.

8. The landing platform of claim 1, further comprising at least two other electrically active portions.

9. The landing platform of claim 1, wherein the at least two other electrically active portions are configured to couple electrically to another drone secured on the landing platform.

10. The landing platform of claim 1, wherein each one of the at least two electrically active portions is not associated with a specified polarity when the drone is not on the platform.

11. The landing platform of claim 1, wherein each one of the at least two electrically active portions is associated with a specified polarity when the drone is on the platform.

12. A luminaire comprising a body fitted with the landing platform of claim 1.

13. A method for charging a drone, the method comprising:
guiding the drone onto a body of a luminaire fitted with a landing platform;
securing the drone onto the landing platform; and
providing electrical contact between connectors of the drone and at least two electrically active portions of the landing platform.

14. The method of claim 13, further comprising performing one of closing and opening a canopy over the landing platform.

15. The method of claim 13, further comprising receiving a command to turn off a propeller of the drone once the drone is secured on the landing platform.

16. The method of claim 14, comprising opening the canopy when a command is received to release the drone.

17. The method of claim 13, further comprising assigning a polarity to one of the at least two electrically active portions.

18. The method of claim 17, wherein the assigning includes sensing an orientation of the drone once it has landed on the platform.

19. The method of claim 13, further comprising landing another drone on the landing platform.

20. The method of claim 19, wherein landing the other drone includes landing the other drone on at least two other electrically active platforms.

21. The method of claim 13, further comprising charging the drone by electric circuitry comprised in the luminaire.

22. A method for charging a drone, the method comprising:
guiding the drone onto a body of a luminaire fitted with the landing platform of claim 1;
securing the drone onto the landing platform; and
providing electrical contact between connectors of the drone and at least two electrically active portions of the landing platform.

23. A drone, comprising:
an undercarriage including at least two brushes configured to provide electrical contact between batteries of the drone and two downwardly sloping electrically active portions of a landing platform mounted on a luminaire.

24. A controller programmable to create an interface between a drone and a power charging circuit included in a luminaire, the controller comprising:
a processor;
a memory including instructions that, when executed by the processor, cause the processor to perform operations including:
detecting the presence of the drone within a predefined radius of the luminaire;
instructing the drone to enter a landing sequence when the drone is found to be present within the predefined radius;
detecting a polarity associated with a connector of the drone, upon the drone having landed on a landing platform of the luminaire;
energizing at least one electrically active portion of the landing platform according to the detected polarity in order to charge batteries of the drone with the power charging circuit.
